(19) United States
(12) Patent Application Publication
(10) Pub. No.: US 2013/0293895 A1
(43) Pub. Date: Nov. 7, 2013

(54) LIGHT SOURCE DEVICE, ANALYSIS DEVICE, AND LIGHT GENERATION METHOD

(71) Applicant: FUJI ELECTRIC CO., LTD., Kawasaki-shi (JP)

(72) Inventor: Masanori OTO, Yokohama-city (JP)

(21) Appl. No.: 13/861,560

(22) Filed: Apr. 12, 2013

Related U.S. Application Data
(63) Continuation of application No. PCT/JP2012/002435, filed on Apr. 6, 2012.

(30) Foreign Application Priority Data
May 26, 2011 (JP) 2011-118054

(51) Int. Cl. G02F 1/37; G01N 21/59; G02F 1/35

(52) U.S. Cl. CPC G02F 1/37; G02F 1/3544; G01N 21/59
USPC 356/432; 359/328

(57) ABSTRACT

In some aspects of the invention, wavelength conversion elements are provided for each of a plurality of laser light sources, and have different wavelength conversion characteristics. In some aspects, each of the wavelength conversion elements converts the wavelength of laser light incident on each of the wavelength conversion elements. The wavelengths of the laser light after wavelength conversion are different from one another. A multiplexer couples the plurality of laser light rays output from the plurality of wavelength conversion elements and outputs the laser light as coaxial light. A VBG (Volume Bragg Grating) is provided between the plurality of laser light sources and the plurality of wavelength conversion elements, and forms at least a portion of a laser light resonator.

### CROSS-REFERENCE TO RELATED APPLICATIONS

This application is a continuation of International Application No. PCT/JP2012/002435, filed on Apr. 6, 2012, which is based on and claims priority to Japanese Patent Application No. JP 2011-118054, filed on May 26, 2011. The disclosure of the Japanese priority application and the PCT application in their entirety, including the drawings, claims, and the specification thereof, are incorporated herein by reference.

### BACKGROUND

1. Field of the Invention

Embodiments of the invention relate to light source devices, analysis devices, and light generation methods.

2. Related Art

In recent years there have been advances in laser light-related technologies. As a result, laser spectroscopy measurements to detect the quantities of specific substances in samples using the absorption intensity of laser light are also becoming more precise. However, among the visible light range, there are no practical laser diodes emitting in the wavelength band from 490 nm to 630 nm. Hence techniques are being developed in which a wavelength conversion element is used to convert near-infrared laser light to light in the 490 nm to 630 nm wavelength band. Techniques related to wavelength conversion elements are for example disclosed in Japanese Patent Application Laid-open No. 2007-147688 (also referred to herein as “Patent Reference 1”), International Patent Application No. WO 2008/044673 (also referred to herein as “Patent Reference 2”) and Japanese Patent Application Laid-open No. 2010-204197 (also referred to herein as “Patent Reference 3”).

The wavelength conversion element disclosed in Patent Reference 1 has the following configuration. A plurality of waveguide paths and multiplexing portions are formed in a substrate comprising a nonlinear optical crystal. In each of the plurality of waveguide paths is formed a second harmonic generation portion. The plurality of second harmonic generation portions have different phase matching wavelengths.

Further, Patent Reference 2 indicates that two fiber Bragg Gratings are provided between a laser diode and a wavelength conversion element. The two fiber Bragg gratings form a laser resonator.

The laser resonator disclosed in Patent Reference 3 has the following configuration. A semiconductor laser has a plurality of light emission points. Light emitted from each of the light emission points is incident on a nonlinear optical element via a Bragg reflection structure. The Bragg reflection structure has a reflection wavelength which changes along the direction of arrangement of the light emission points. The polarization inversion direction of the nonlinear optical element changes along the direction of light propagation. It is indicated that as a result, the laser light wavelength width can be expanded to several nanometers.

Gas absorption line widths are generally narrow. Hence when a sample is air or another gas, and the substance for detection is a gas, in order to perform laser spectroscopy measurements with high precision, the laser light wavelength width must be made narrower than the absorption line width. Further, in order to perform laser spectroscopy measurements there are demands for emission of light at a plurality of wavelengths from a single optical axis, for performing modulation independently for each wavelength, and for reducing costs.

However, using the technique disclosed in Patent Reference 1, a plurality of second harmonic generation portions must be provided in a single nonlinear optical crystal. Consequently when one second harmonic generation portion has become defective, other second harmonic generation portions also become defective. Hence it is possible that the cost of manufacturing the nonlinear optical crystal may rise.

Further, using the technique disclosed in Patent Reference 2, light at a plurality of wavelengths cannot be emitted from a single optical axis. And using the technique disclosed in Patent Reference 3, the polarization inversion direction in the nonlinear optical element changes along the direction of light propagation, so that the laser light wavelength width expands.

Therefore, as described above, there are certain shortcomings in the related art.

### SUMMARY OF THE INVENTION

Embodiments of the invention address these and other shortcomings in the art. Embodiments of the invention provide a light source device which can emit light at a plurality of wavelengths from a single optical axis, can perform modulation independently for each wavelength, and is inexpensive, as well as an analysis device and a light generation method.

In some embodiments, a light source device of has a plurality of laser light sources, a plurality of wavelength conversion elements, a multiplexer, and a first Bragg reflection portion. The plurality of laser light sources output laser light. The wavelength conversion elements are provided for each of the laser light sources, and have different wavelength conversion characteristics. Each wavelength conversion element converts the wavelength of the laser light incident on the wavelength conversion element. The wavelengths of laser light after wavelength conversion are different from one another. The multiplexer couples a plurality of laser light rays output from the plurality of wavelength conversion elements, and outputs the laser light as coaxial light. The first Bragg reflection portion is provided between the plurality of laser light sources and wavelength conversion elements, and forms at least a portion of a laser light resonator.

In some embodiments, light at a plurality of wavelengths can be emitted from a single optical axis. Further, by controlling each of the plurality of laser light sources, modulation can be performed independently for each wavelength. Further, a configuration is used in which wavelength conversion elements are independent, so that increases in manufacturing costs of wavelength conversion elements can be suppressed.

An analysis device in accordance with some embodiments has the light source device described above and an analysis portion. The analysis portion irradiates a sample with light output from the light source device and measures the amount of light absorption in the sample.

In some embodiments, laser light from each of a plurality of laser light sources is output. The plurality of laser light rays are input to different wavelength conversion elements. The plurality of wavelength conversion elements have different wavelength conversion characteristics, and convert input laser light into different wavelengths. A laser light resonator is provided on the laser light source side of the plurality of wavelength conversion elements. By using a multiplexer, the plurality of laser light rays output from the plurality of wavelength conversion elements are coupled, and the result is output as coaxial light.

By means of some embodiments, a light source device which can emit light at a plurality of wavelengths from the same optical axis, and can perform modulation independently for each wavelength, and moreover is inexpensive, as well as an analysis device and a light generation method, can be provided.

### BRIEF DESCRIPTION OF THE DRAWINGS

The above-described features and advantageous results, will become clear through the embodiments described below and the drawings attached thereto.

FIG. 1 shows the configuration of the light source device of a first embodiment;

FIG. 2 shows the configuration of the light source device of a second embodiment;

FIG. 3 shows the configuration of the light source device of a third embodiment;

FIG. 4 shows the configuration of the light source device of a fourth embodiment; and

FIG. 5 shows the configuration of the light source device of a fifth embodiment.

### DETAILED DESCRIPTION

Below, embodiments of the invention are explained using the drawings. In general, in the drawings, the same constituent elements are assigned the same symbols, and explanations are omitted as appropriate.

### First Embodiment

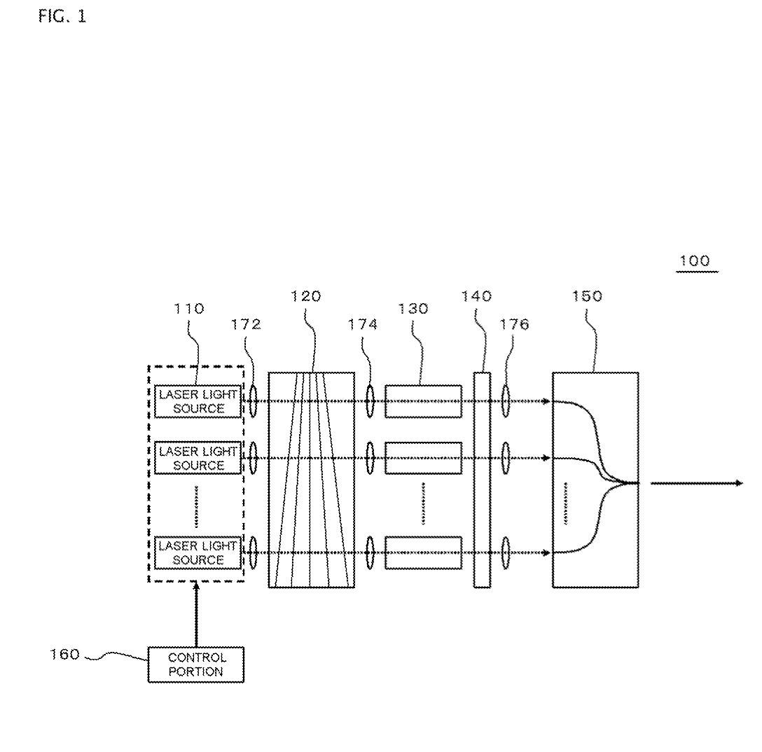

FIG. 1 shows the configuration of the light source device 100 of a first embodiment. The light source device 100 comprises a plurality of laser light sources 110, a plurality of wavelength conversion elements 130, a multiplexer 150, and a VBG (Volume Bragg Grating) 120 (first Bragg reflection portion). The wavelength conversion elements 130 are provided for each of the plurality of laser light sources 110, and have different wavelength conversion characteristics. Each wavelength conversion element 130 converts the wavelength of laser light incident on the wavelength conversion element. The wavelengths of laser light after wavelength conversion are different. The multiplexer 150 couples the plurality of laser light rays output from the plurality of wavelength conversion elements 130, and outputs the result as coaxial light. The VBG 120 is provided between the plurality of laser light sources 110 and the plurality of wavelength conversion elements 130, and forms at least a portion of a laser light resonator. Details are explained below.

The plurality of laser light sources 110 are all semiconductor lasers. The frequencies of oscillation laser light (pump light) of the laser light sources 110 may be the same, or may be different. The frequencies of oscillation of the laser light sources 110 used are determined by the application of the light source device. The outputs of the plurality of laser light sources 110 are controlled by a control portion 160. The control portion 160 directly controls the outputs of the laser light sources 110 by controlling the currents input to the laser light sources 110. The frequencies of the laser light output by the laser light sources 110 are for example in the near-infrared region. In this case, the wavelengths of light output from the multiplexer 150 are 490 nm or greater and 630 nm or less.

A lens 172 is provided between the laser light sources 110 and the VBG 120. The faces of the laser light sources 110 opposing the lens 172 have an anti-reflection coating, and moreover the faces on the reverse side have a reflective coating. The VBG 120 and the laser light sources 110 form a resonator for the laser light resulting from oscillation of the laser light sources 110. The gain medium of the resonator is the semiconductor lasers used as the laser light sources 110.

The VBG 120 is a bulk element within which exists a portion in which the refractive index changes periodically. The VBG 120 is formed for example from an inorganic material the main starting material of which is silica glass. However, the starting material of the VBG 120 is not limited thereto. The periodic change in refractive index in the VBG 120 is formed by for example ultraviolet ray irradiation and heat treatment.

One VBG 120 is provided for a plurality of laser light sources 110. The reflection wavelength of the VBG 120 changes in a direction perpendicular to the direction of advance of laser light. In this embodiment, the plurality of laser light sources 110 all have the same oscillation frequency. However, the wavelength of light output by the laser light sources 110 has certain widths. The wavelength of the light output from the VBG 120 is determined by the position of the VBG 120 which a laser light source 110 faces. That is, the plurality of laser light sources 110 face positions of the VBG 120 such that the desired frequency is the reflected frequency.

The wavelength conversion elements 130 are quasi-phase matching elements, and are for example formed from LiNbO₃, LiTaO₃, or another ferroelectric crystal. Laser light output from the VBG 120 is incident via a lens 174 on a wavelength conversion element 130. A wavelength conversion element 130 has a periodic polarization inversion region. The polarization inversion periods of the plurality of wavelength conversion elements 130 are different. The wavelength conversion elements 130 generate and emit a harmonic frequency, such as for example the second harmonic, of the incident laser light. The period of polarization inversion of the wavelength conversion elements 130 is determined by the wavelength of the laser light incident on the wavelength conversion element 130 and the wavelength of the light to be output by the wavelength conversion element 130. Further, the temperatures of the wavelength conversion elements 130 can be controlled using for example Peltier elements.

Laser light output from a wavelength conversion element 130 is incident on the multiplexer 150 via an optical filter 140 and a lens 176. The optical filter 140 eliminates light having the wavelength of the oscillation frequency of the laser light source 110. In the multiplexer 150 are formed waveguide paths at positions opposing each of the wavelength conversion elements 130. These waveguide paths are brought together into one on the output side. Hence in the multiplexer 150, the plurality of laser light rays output from the plurality of wavelength conversion elements 130 are output as coaxial light.

Next, action and advantageous results of the embodiment are explained. By means of the light source device 100, the control portion 160 controls the outputs of the laser light sources 110 independently. Hence when modulating the output of any of the laser light sources 110, there is no effect on the outputs of any of the other light sources 110.

Further, laser light can be output simultaneously from the plurality of laser light sources 110, and harmonics of the laser light can be output as coaxial light. Hence by irradiating a sample with different laser light rays simultaneously, sample analysis at a plurality of wavelengths can be performed simultaneously. By this means, sample analysis can be performed at high speed. This advantageous effect is particularly prominent when the sample is scanned with light and mapping is performed in two dimensions or in three dimensions.

Further, a configuration is used in which the wavelength conversion elements 130 are independent, so that increases in manufacturing costs of the wavelength conversion elements 130 can be suppressed.

Further, the resonator of the laser light sources 110 is formed by the VBG 120 and the reflective coatings formed on one face of the laser light sources 110. The resonance frequency of this resonator is fixed. Hence even if the output of the laser light sources 110 is modulated, the wavelength of the laser light incident on the wavelength conversion elements 130 does not change. Consequently when the output of the laser light sources 110 is modulated, phase mismatching with respect to the wavelength conversion elements 130 of light incident on the wavelength conversion elements 130 can be suppressed.

### Second Embodiment

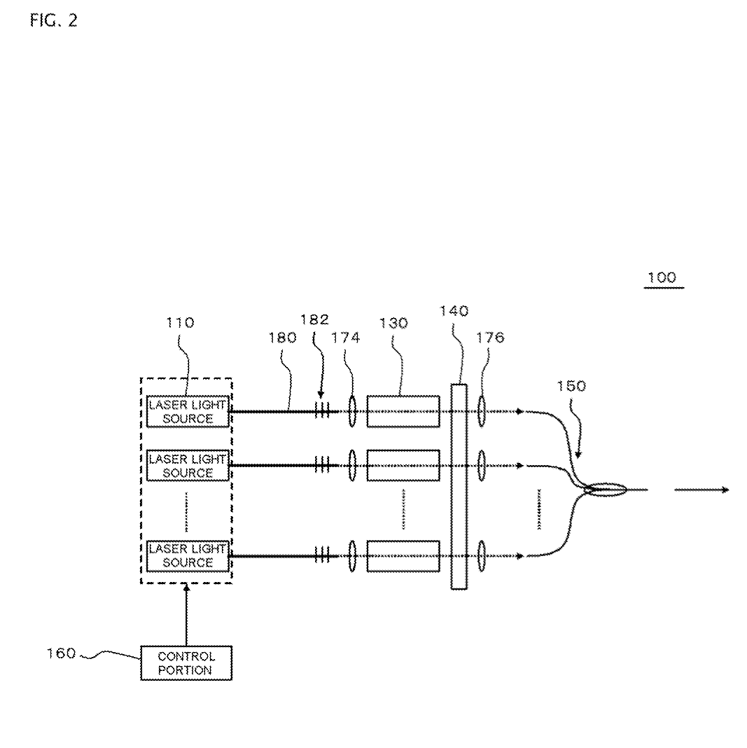

FIG. 2 shows the configuration of the light source device 100 of a second embodiment. The light source device 100 of this embodiment has a configuration similar to that of the light source device 100 of the first embodiment, except in the following respects.

First, in place of the VBG 120, a plurality of optical fibers 180 are comprised. The optical fibers 180 are provided respectively for the laser light sources 110. The laser light sources 110 and the optical fibers 180 may be directly coupled, or may be coupled via a lens. FBGs (Fiber Bragg Gratings) 182 are provided in the optical fibers 180. The reflection frequency of the FBGs 182 coincide with the oscillation frequencies of the laser light sources 110 corresponding to the optical fibers 180. Resonators of the laser light sources 110 are formed by the FBGs 182 and the reflective coatings provided at one end of the laser light sources 110.

The multiplexer 150 is an optical fiber type multiplexer.

By means of this embodiment also, advantageous results similar to those of the first embodiment can be obtained.

### Third Embodiment

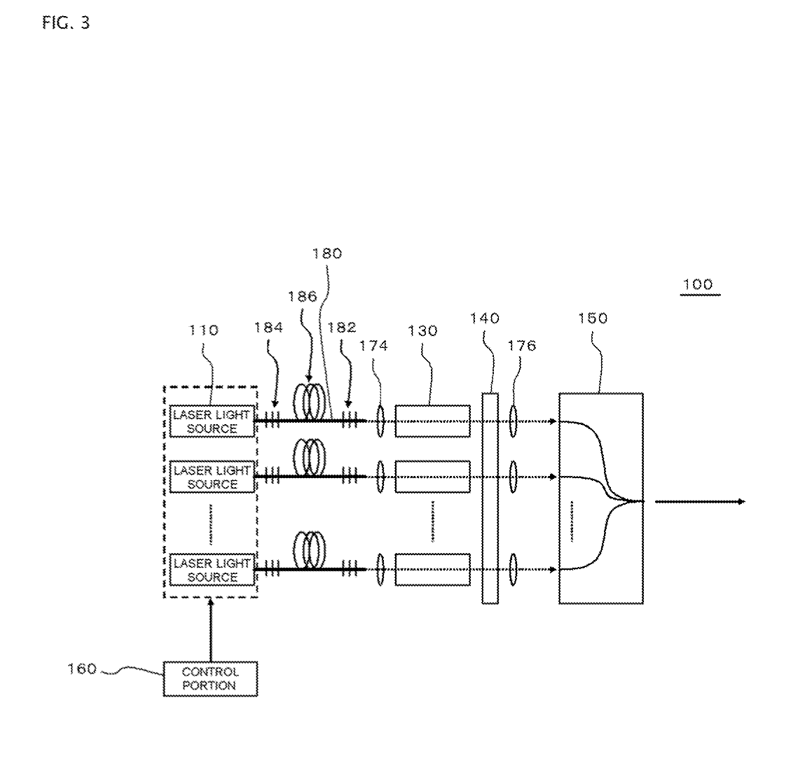

FIG. 3 shows the configuration of the light source device 100 of a third embodiment. The light source device 100 of this embodiment has the same configuration as the light source device 100 of the second embodiment, except in the following respects.

First, an FBG 184 is provided, in addition to the FBG 182, in each of the optical fibers 180. An FBG 184 is positioned closer to the laser light source 110 than the FBG 182. The reflection frequency of an FBG 182 coincides with the oscillation frequency of the laser light source 110 corresponding to the optical fiber 180. Further, at least a portion of the optical fiber 180 is a rare earth-doped fiber 186. The rare earth-doped fiber 186 is positioned between the FBG 182 and the FBG 184. That is, in this embodiment, resonators for laser light output by the laser light sources 110 are formed by the FBGs 182 and the FBGs 184. The gain media of the resonators are the rare earth-doped fibers 186.

By means of this embodiment also, advantageous results similar to those of the first embodiment can be obtained.

### Fourth Embodiment

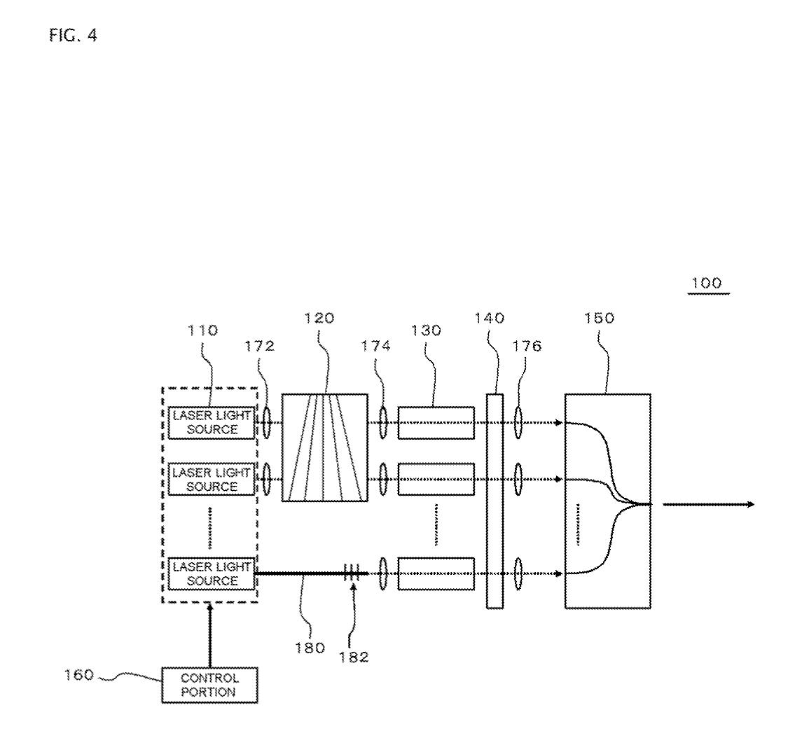

FIG. 4 shows the configuration of the light source device 100 of a fourth embodiment. The light source device 100 of this embodiment has the same configuration as the light source device 100 of the first embodiment, except that a VBG 120 is provided corresponding to a portion of the laser light sources 110, and an optical fiber 180 and an FBG 182 are provided for the other laser light sources 110. The configuration of the optical fiber 180 and the FBG 182 is as explained in the second embodiment.

By means of this embodiment also, advantageous results similar to those of the first embodiment can be obtained.

### Fifth Embodiment

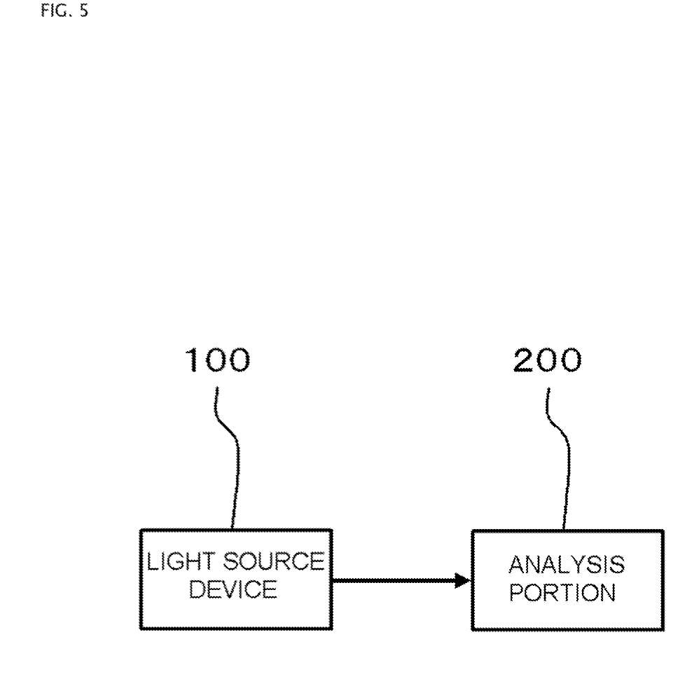

FIG. 5 shows the configuration of the analysis device of a fifth embodiment. This analysis device has a light source device 100 and an analysis portion 200. The light source device 100 has the configuration of any one of the first to fourth embodiments. The analysis portion 200 irradiates a sample with light output from the light source device 100, and measures the amount of absorption of light in the sample. The sample is for example air or another gas. By measuring the amount of absorption of light in the sample, the analysis portion 200 detects the amount of a specific component (for example, radicals, or carbon dioxide or another dilute gas included in air) included in the sample. When the component for detection is carbon dioxide, the wavelength of the light output by the light source device 100 can be varied between 490 nm or greater and 630 nm or less. In this case, light in the near-infrared region is output from the laser light sources 110 (shown in FIG. 1 to FIG. 4) of the light source device 100.

As described above, the light source device 100 can cause output of laser light simultaneously from a plurality of laser light sources 110, and can output harmonics of these laser light rays as coaxial light. Hence by simultaneously irradiating a sample with different laser light rays, the sample can be simultaneously analyzed using light at a plurality of wavelengths. By this means, rapid sample analysis can be performed. This advantageous effect is particularly prominent when the sample is scanned with light to perform two-dimensional or three-dimensional mapping.

### Example

The light source device 100 shown in FIG. 1 was fabricated using two laser light sources 110. As the laser light sources 110, semiconductor lasers, the main component of which was InP, were used. The first laser light source 110 was opposed to the portion of the VBG 120 at which the reflection frequency was 1080 nm, and the second laser light source 110 was opposed to the portion of the VBG 120 at which the reflection frequency was 1100 nm. As the wavelength conversion elements 130, quasi-phase matching elements comprising Mg-doped LiNbO₃ were used.

As a result, laser light of wavelength 540 nm and laser light of wavelength 550 nm were output from the multiplexer 150. The optical axes of these two laser light rays coincided.

Further, using the control portion 160, the currents input to the two laser light sources 110 were changed independently. It was confirmed that, as a result, the intensities of the two laser light rays output from the multiplexer 150 changed independently.

In the above, embodiments of the invention have been explained referring to the drawings; but the embodiments are merely exemplifications, and various configurations other than those described above can be adopted. For example, a light source device 100 may also be used for measurement and as a light source in measurement fields of medicine, biology and similar, or may be used as a light source for plasma measurements.

Examples of specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the above description, specific details are set forth in order to provide a thorough understanding of embodiments of the invention. Embodiments of the invention may be practiced without some or all of these specific details. Further, portions of different embodiments and/or drawings can be combined, as would be understood by one of skill in the art.

What is claimed is:

1. A light source device, comprising:
a plurality of laser light sources;
a plurality of wavelength conversion elements provided for each of the plurality of laser light sources and having different wavelength conversion characteristics, and moreover converting laser light into different wavelengths;
a multiplexer coupling the plurality of laser light rays output from the plurality of wavelength conversion elements and outputting the rays as coaxial light; and
a first Bragg reflection portion provide between the plurality of laser light sources and the plurality of wavelength conversion elements and forming at least one portion of a resonator for the laser light, wherein
a VBG (Volume Bragg Grating) element, which is the first Bragg reflection portion, is provided between at least one of the plurality of laser light sources and the wavelength conversion element corresponding to the laser light source,
the laser light source for which the VBG element is provided faces the VBG element at a position where a desired frequency exhibits a reflection frequency of the VBG element.

2. The light source device according to claim 1, wherein at least one of the plurality of laser light sources is a semiconductor laser, a face of the semiconductor layer on a side of the first Bragg reflection portion has an anti-reflection coating and a face on an opposite side has a reflective coating, and the resonator corresponding to the semiconductor layer is formed by the first Bragg reflection portion and the semiconductor laser.

3. The light source device according to claim 2, wherein the first Bragg reflection portion is a VBG element.

4. The light source device according to claim 2, wherein the plurality of laser light sources are all semiconductor lasers, and the reflection wavelength of the VBG changes in a direction perpendicular to a direction of advance of the laser light.

5. The light source device according to claim 2, wherein an optical fiber is provided between the semiconductor laser for which the VBG element is not provided and the wavelength conversion element corresponding to the laser light source, and the first Bragg reflection portion provided for the semiconductor laser for which the VBG element is not provided is a FBG (Fiber Bragg Grating) provided in the optical fiber.

6. The light source device according to claim 1, wherein the plurality of wavelength conversion elements are quasi-phase matching elements with different polarization inversion periods.

7. The light source device according to claim 1, comprising a control portion which independently controls the plurality of laser light sources.

8. The light source device according to claim 1, wherein a wavelength of the laser light is in a near-infrared region, and a wavelength of light output from the light source device is 490 nm or greater and 630 nm or less.

9. An analysis device, comprising:
a light source device; and an analysis portion which irradiates a sample with light output from the light source device and measures an amount of absorption of the light in the sample, wherein
the light source device has:
a plurality of laser light sources;
a plurality of wavelength conversion elements, provided for each of the plurality of laser light sources having different wavelength conversion characteristics, and converting laser light into different wavelengths;
a multiplexer coupling the plurality of laser light rays output from the plurality of wavelength conversion elements and outputting the rays as coaxial light; and
a first Bragg reflection portion provide between the plurality of laser light sources and the plurality of wavelength conversion elements and forming at least one portion of a resonator for the laser light.

10. A light generation method comprising:
preparing a plurality of laser light sources which output laser light at different wavelengths;
providing, for the respective plurality of laser light sources, a plurality of wavelength conversion elements having different wavelength conversion characteristics and converting the laser light into light at different wavelengths;
providing, on the laser light source side of the plurality of wavelength conversion elements, a resonator of the laser light; and
by using the resonator, coupling the plurality of laser light rays output from the plurality of wavelength conversion elements, and outputting the laser light as coaxial light.
